(19) United States
(12) Patent Application Publication
(10) Pub. No.: US 2006/0135653 A1
(43) Pub. Date: Jun. 22, 2006

(54) Electronic molding composition and method

(75) Inventors: Kenneth Paul Zarnoch, Scotia, NY (US); Prameela Susarla, Clifton Park, NY (US); Michael Alan Vallance, Loudonville, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/022,906

(22) Filed: Dec. 22, 2004

(51) Int. Cl. C08K 9/00; B32B 13/04

(52) U.S. Cl. 523/205; 523/209; 428/446

(57) ABSTRACT

A curable molding composition is provided having a binder system and a filler system. The molding composition is useful as an electronic material composition for electronic devices.

### BACKGROUND OF THE INVENTION

This invention relates to curable compositions and specifically compositions and method of preparing electronic molding compounds.

Electronic molding compounds are used to encapsulate delicate electronic devices. The requirements placed on the packaged devices include resistance to burning which can be satisfied by demonstrating that the molding compound has a self-extinguishing characteristic and resistance to blistering during solder reflow at temperatures as high as 250° C. Blistering during solder reflow is known to involve desorption and boiling of retained moisture; therefore hydrophobicity of the cured molding compound is a key design feature.

### BRIEF DESCRIPTION OF THE INVENTION

In one embodiment, the present invention relates to a composition comprising: (a) a curable binder, said binder comprising at least one functionalized poly(arylene ether) and at least one olefinically unsaturated monomer; and (b) a filler, said filler comprising a coating of hydrolyzed, condensed poly (silane).

In yet another embodiment of the present invention is an electronic device comprising: (a) a substrate; and (b) an electronic material composition adjacent to said substrate, said electronic material composition comprising a curable binder, said binder comprising at least one functionalized poly(arylene ether) and at least one olefinically unsaturated monomer, and a filler wherein the filler comprises a coating of hydrolyzed, condensed poly (silane).

In yet another embodiment of the present invention is a method for making an electronic material composition, said method comprising: (a) providing a curable binder, said binder comprising at least one functionalized poly(arylene ether) and at least one olefinically unsaturated monomer; (b) providing a filler comprising a coating of hydrolyzed, condensed poly (silane); (c) mixing said binder and filler to form a blend to yield said electronic material composition.

In yet another embodiment of the present invention is a method for producing an electronic device whereby a substrate-mounted electronic device or circuit is at least partially encapsulated by an electronic material composition, said composition comprising: (a) a curable binder, said binder comprising at least one functionalized poly(arylene ether) and at least one olefinically unsaturated monomer; and (b) a filler comprising a coating of hydrolyzed, condensed poly (silane).

### BRIEF DESCRIPTION OF THE DRAWINGS

Referring to the exemplary drawing wherein like elements are numbered alike in the accompanying Figure;

FIG. 1 is a schematic diagram of an electronic device assembly encapsulated by a curable composition of one embodiment of the present invention;

FIG. 2 shows the comparison of flexural strengths of samples prepared from different compositions;

FIG. 3 shows the comparison of strain-to-break values of samples prepared from different compositions; and

FIG. 4 shows the flexural modulus of samples prepared from different compositions.

### DETAILED DESCRIPTION OF THE INVENTION

Disclosed herein, in one embodiment, is an electronic material composition comprising a curable binder and a filler, wherein the filler comprises a coating of hydrolyzed condensed poly(silane). The curable binder comprises at least one functionalized poly(arylene ether) and at least one olefinically unsaturated monomer.

The functionalized poly(arylene ether) may be a capped poly(arylene ether), a ring-functionalized poly(arylene ether), or an acid- or anhydride-functionalized poly(arylene ether), or any combination of these poly(arylene ethers).

A capped poly(arylene ether) is defined herein as a poly(arylene ether) in which at least 50%, preferably at least 75%, more preferably at least 90%, yet more preferably at least 95%, even more preferably at least 99%, of the free hydroxyl groups present in the corresponding uncapped poly(arylene ether) have been functionalized by reaction with a capping agent. The capped poly(arylene ether) may be represented by the structure
Q(J-K)_{y}
wherein Q is the residuum of a monohydric, dihydric, or polyhydric phenol, preferably the residuum of a monohydric or dihydric phenol, more preferably the residuum of a monohydric phenol; y is 1 to 100; J comprises repeating structural units having the formula 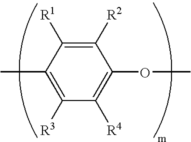
wherein m is 1 to about 200, preferably 2 to about 200, and R¹ and R³ are each independently hydrogen, halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; R² and R⁴ are each independently halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; and K is a capping group produced by reaction of a phenolic hydroxyl group on the poly(arylene ether) with a capping agent. The resulting capping group, K, may be 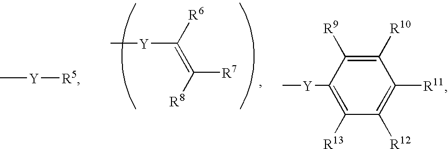
or the like, wherein R⁵ is C₁-C₁₂ hydrocarbyl optionally substituted with one or two carboxylic acid groups, or the like; R⁶-R⁸ are each independently hydrogen, C₁-C₁₈ hydrocarbyl optionally substituted with one or two carboxylic acid groups, C₂-C₁₈ hydrocarbyloxycarbonyl, nitrile, formyl, carboxylic acid, imidate, thiocarboxylic acid, or the like; R⁹-R¹³ are each independently hydrogen, halogen, C₁-C₁₂ alkyl, hydroxy, amino, carboxylic acid, or the like; and wherein Y is a divalent group such as 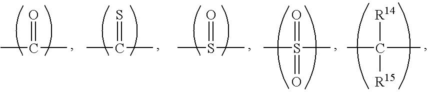 or the like, wherein R¹⁴ and R¹⁵ are each independently hydrogen, C₁-C₁₂ alkyl, or the like.

As used herein, “hydrocarbyl” refers to a residue that contains only carbon and hydrogen. The residue may be aliphatic or aromatic, straight-chain, cyclic, bicyclic, branched, saturated, or unsaturated. The hydrocarbyl residue, when so stated however, may contain heteroatoms over and above the carbon and hydrogen members of the substituent residue. Thus, when specifically noted as containing such heteroatoms, the hydrocarbyl residue may also contain carbonyl groups, amino groups, hydroxyl groups, carboxylic acid groups, halogen atoms, or the like, or it may contain heteroatoms within the backbone of the hydrocarbyl residue.

In one embodiment, Q is the residuum of a phenol, including polyfunctional phenols, and includes radicals of the structure 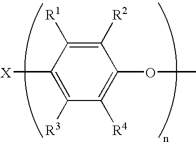
wherein R¹ and R³ are each independently hydrogen, halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; R² and R⁴ are each independently halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; X may be hydrogen, C₁-C₁₈ hydrocarbyl, or C₁-C₁₈ hydrocarbyl containing a substituent such as carboxylic acid, aldehyde, alcohol, amino radicals, or the like; X also may be sulfur, sulfonyl, sulfuryl, oxygen, or other such bridging group having a valence of 2 or greater to result in various bis- or higher polyphenols; n (i.e., the number of phenylene ether units bound to X) is 1 to about 100, preferably 1 to 3, and more preferably 1 to 2. Q may be the residuum of a monohydric phenol, such as 2,6-dimethylphenol, in which case n is 1. Q may also be the residuum of a diphenol, such as 2,2′,6,6′-tetramethyl-4,4′-diphenol, in which case n is 2.

In one embodiment, the uncapped poly(arylene ether) may be defined by reference to the capped poly(arylene ether) Q(J-K), as Q(J-H), where Q, J and y are defined above, and a hydrogen atom, H, has taken the place of any capping group, K. In one embodiment, the uncapped poly(arylene ether) consists essentially of the polymerization product of at least one monohydric phenol having the structure 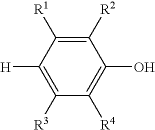
wherein R¹ and R³ are each independently hydrogen, halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; and R² and R⁴ are each independently halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like. Suitable monohydric phenols include those described, for example, in U.S. Pat. No. 3,306,875 to Hay, and highly preferred monohydric phenols include 2,6-dimethylphenol and 2,3,6-trimethylphenol. The poly(arylene ether) may be a copolymer of at least two monohydric phenols, such as 2,6-dimethylphenol and 2,3,6-trimethylphenol. Thus the uncapped poly(arylene ether) may comprise poly(2,6-dimethyl-1,4-phenylene ether), poly(2,6-dimethyl-1,4-phenylene ether-co-2,3,6-trimethyl-1,4-phenylene ether) or a mixture thereof. In yet another embodiment, the uncapped poly(arylene ether) is isolated by precipitation and preferably has less than about 400 parts per million of organic impurities and more preferably less than about 300 parts per million. Organic impurities include, for example, 2,3-dihydrobenzofuran, 2,4,6-trimethylanisole, 2,6-dimethylcyclohexanone, 7-methyl-2,3-dihydrobenzofuran, and the like.

In one embodiment, the capped poly(arylene ether) comprises at least one capping group having the structure 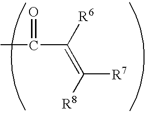
wherein R⁶-R⁸ are each independently hydrogen, C₁-C₁₈ hydrocarbyl optionally substituted with one or two carboxylic acid groups, C₂-C₁₈ hydrocarbyloxycarbonyl, nitrile, formyl, carboxylic acid, imidate, thiocarboxylic acid, or the like. Highly preferred capping groups include acrylate (R⁶=R⁷=R⁸=hydrogen) and methacrylate (R⁶=methyl, R⁷=R⁸=hydrogen). It will be understood that the term “(meth)acrylate” means either acrylate or methacrylate.

In another embodiment, the capped poly(arylene ether) comprises at least one capping group having the structure 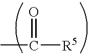
wherein R⁵ is C₁-C₁₂ hydrocarbyl optionally substituted with one or two carboxylic acid groups, preferably C₁-C₆ alkyl, more preferably methyl, ethyl, or isopropyl. The advantageous properties of the invention can be achieved even when the capped poly(arylene ether) lacks a polymerizable function such as a carbon-carbon double bond.

In yet another embodiment, the capped poly(arylene ether) comprises at least one capping group having the structure 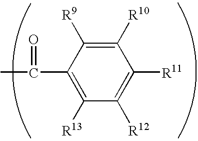
wherein R⁹-R¹³ are each independently hydrogen, halogen, C₁-C₁₂ alkyl, hydroxy, amino, carboxylic acid, or the like. Preferred capping groups of this type include salicylate (R⁹=hydroxy, R¹⁰-R¹³=hydrogen).

In still another embodiment, the capped poly(arylene ether) comprises at least one capping group having the structure 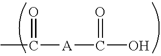
wherein A is a saturated or unsaturated C₂-C₁₂ divalent hydrocarbon group such as, for example, ethylene, 1,2-propylene, 1,3-propylene, 2-methyl-1,3-propylene, 2,2-dimethyl-1,3-propylene, 1,2-butylene, 1,3-butylene, 1,4-butylene, 2-methyl-1,4-butylene, 2,2-dimethyl-1,4-butylene, 2,3-dimethyl-1,4-butylene, vinylene (—CH═CH—), 1,2-phenylene, and the like. These capped poly(arylene ether) resins may conveniently be prepared, for example, by reaction of an uncapped poly(arylene ether) with a cyclic anhydride capping agent. Such cyclic anhydride capping agents include, for example, maleic anhydride, succinic anhydride, glutaric anhydride, adipic anhydride, phthalic anhydride, and the like.

There is no particular limitation on the method by which the capped poly(arylene ether) is prepared. The capped poly(arylene ether) may be formed by the reaction of an uncapped poly(arylene ether) with a capping agent. Capping agents include compounds known in the literature to react with phenolic groups. Such compounds include both monomers and polymers containing, for example, anhydride, acid chloride, epoxy, carbonate, ester, isocyanate, cyanate ester, or alkyl halide radicals. Phosphorus and sulfur based capping agents also are included. Examples of capping agents include, for example, acetic anhydride, succinic anhydride, maleic anhydride, salicylic anhydride, polyesters comprising salicylate units, homopolyesters of salicylic acid, acrylic anhydride, methacrylic anhydride, glycidyl acrylate, glycidyl methacrylate, acetyl chloride, benzoyl chloride, diphenyl carbonates such as di(4-nitrophenyl)carbonate, acryloyl esters, methacryloyl esters, acetyl esters, phenylisocyanate, 3-isopropenyl-α,α-dimethylphenylisocyanate, cyanatobenzene, 2,2-bis(4-cyanatophenyl)propane, 3-(α-chloromethyl)styrene, 4-(α-chloromethyl)styrene, allyl bromide, and the like, and substituted derivatives thereof, and mixtures thereof. These and other methods of forming capped poly(arylene ether)s are described, for example, in U.S. Pat. No. 3,375,228 to Holoch et al.; U.S. Pat. No. 4,148,843 to Goossens; U.S. Pat. Nos. 4,562,243, 4,663,402, 4,665,137, and U.S. Pat. No. 5,091,480 to Percec et al.; U.S. Pat. Nos. 5,071,922, 5,079,268, 5,304,600, and 5,310,820 to Nelissen et al.; U.S. Pat. No. 5,338,796 to Vianello et al.; U.S. Patent Application Publication No. 2001/0053820 Al to Yeager et al.; and European Patent No. 261,574 B1 to Peters et al.

A capping catalyst may be employed in the reaction of an uncapped poly(arylene ether) with an anhydride. Examples of such compounds include those known to the art that are capable of catalyzing condensation of phenols with the capping agents described above. Useful materials include, but are not limited to, basic compounds including, for example, basic compound hydroxide salts such as sodium hydroxide, potassium hydroxide, tetraalkylammonium hydroxides, and the like; tertiary alkylamines such as tributylamine, triethylamine, dimethylbenzylamine, dimethylbutylamine and the like; tertiary mixed alkyl-arylamines and substituted derivatives thereof such as N,N-dimethylaniline; heterocyclic amines such as imidazoles, pyridines, and substituted derivatives thereof such as 2-methylimidazole, 2-vinylimidazole, 4-dimethylaminopyridine, 4-(1-pyrrolino)pyridine, 4-(1-piperidino)pyridine, 2-vinylpyridine, 3-vinylpyridine, 4-vinylpyridine, and the like. Also useful are organometallic salts such as, for example, tin and zinc salts known to catalyze the condensation of, for example, isocyanates or cyanate esters with phenols. The organometallic salts useful in this regard are known to the art in numerous publications and patents well known to those skilled in this art.

The functionalized poly(arylene ether), may, in one embodiment, be a ring-functionalized poly(arylene ether). In one embodiment, the ring-functionalized poly(arylene ether) is a poly(arylene ether) comprising repeating structural units of the formula 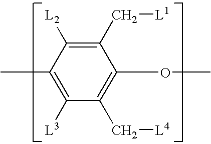
wherein each L¹-L⁴ is independently hydrogen, a C₁-C₁₂ alkyl group, an alkenyl group, or an alkynyl group; wherein the alkenyl group is represented by 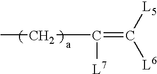
wherein L⁵-L⁷ are independently hydrogen or methyl, and a is 0, 1, 2, 3, or 4; wherein the alkynyl group is represented by 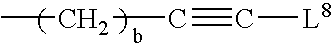
wherein L⁸ is hydrogen, methyl, or ethyl, and b is 0, 1, 2, 3, or 4; and wherein about 0.02 mole percent to about 25 mole percent of the total L¹-L⁴ substituents in the ring-functionalized poly(arylene ether) are alkenyl and/or alkynyl groups. Within this range, it may be preferred to have at least about 0.1 mole percent, more preferably at least about 0.5 mole percent, alkenyl and/or alkynyl groups. Also within this range, it may be preferred to have up to about 15 mole percent, more preferably up to about 10 mole percent, alkenyl and/or alkynyl groups.

The ring-functionalized poly(arylene ether) may be prepared according to known methods. For example, an unfunctionalized poly(arylene ether) such as poly(2,6-dimethyl-1,4-phenylene ether) may be metallized with a reagent such as n-butyl lithium and subsequently reacted with an alkenyl halide such as allyl bromide and/or an alkynyl halide such as propargyl bromide. This and other methods for preparation of ring-functionalized poly(arylene ether) resins are described, for example, in U.S. Pat. No. 4,923,932 to Katayose et al.

In another embodiment, the functionalized poly(arylene ether) is the product of the melt reaction of a poly(arylene ether) and an α,β-unsaturated carbonyl compound or a β-hydroxy carbonyl compound to produce an acid- or anhydride-functionalized poly(arylene ether). In some embodiments both acid and anhydride functionality may be present. Examples of α,β-unsaturated carbonyl compounds include, for example, fumaric acid, maleic acid, maleic anhydride, itaconic acid, itaconic anhydride, citraconic acid, citraconic anhydride, as well as various derivatives of the foregoing and similar compounds. Examples of β-hydroxy carbonyl compounds include, for example, citric acid, malic acid, and the like. Such functionalization is typically carried out by melt mixing the poly(arylene ether) with the desired carbonyl compound at a temperature of about 190 to about 290° C.

There is no particular limitation on the molecular weight or intrinsic viscosity of the functionalized poly(arylene ether). In one embodiment, the composition may comprise a functionalized poly(arylene ether) having a number average molecular weight of about 1,000 to about 25,000atomic mass units (AMU). Within this range, it may be preferable to use a functionalized poly(arylene ether) having a number average molecular weight of at least about 2,000 AMU, more preferably at least about 4,000 AMU. In another embodiment, the composition may comprise a functionalized poly(arylene ether) having an intrinsic viscosity of about 0.05 to about 0.6 deciliters per gram (dL/g) as measured in chloroform at 25° C. Within this range, the functionalized poly(arylene ether) intrinsic viscosity may preferably be at least about 0.08 dL/g, more preferably at least about 0.1 dL/g. Also within this range, the functionalized poly(arylene ether) intrinsic viscosity may preferably be up to about 0.5 dL/g, still more preferably up to about 0.4 dL/g. Generally, the intrinsic viscosity of a functionalized poly(arylene ether) will vary insignificantly from the intrinsic viscosity of the corresponding unfunctionalized poly(arylene ether). Specifically, the intrinsic viscosity of a functionalized poly(arylene ether) will generally be within 10% of that of the unfunctionalized poly(arylene ether). It is expressly contemplated to employ blends of at least two functionalized poly(arylene ether)s having different molecular weights and intrinsic viscosities. The composition may comprise a blend of at least two functionalized poly(arylene ethers). Such blends may be prepared from individually prepared and isolated functionalized poly(arylene ethers). Alternatively, such blends may be prepared by reacting a single poly(arylene ether) with at least two functionalizing agents. For example, a poly(arylene ether) may be reacted with two capping agents, or a poly(arylene ether) may be metallized and reacted with two unsaturated alkylating agents. In another alternative, a mixture of at least two poly(arylene ether) resins having different monomer compositions and/or molecular weights may be reacted with a single functionalizing agent. The composition may, optionally, comprise a blend of a functionalized poly(arylene ether) resin and an unfunctionalized poly(arylene ether) resin, and these two components may, optionally, have different intrinsic viscosities. In one embodiment, the functionalized poly(arylene ether) comprises poly phenylene ether (PPO).

The curable composition may comprise about 5 to about 90 parts by weight of the functionalized poly(arylene ether) per 100 parts by weight total of the functionalized poly(arylene ether) and the olefinically unsaturated monomer. Within this range, the amount of the functionalized poly(arylene ether) resin may preferably be at least about 10 parts by weight, more preferably at least about 15 parts by weight. Also within this range, the amount of the functionalized poly(arylene ether) resin may preferably be up to about 80 parts by weight, more preferably up to about 60 parts by weight, still more preferably up to about 50 parts by weight.

The curable composition also comprises an olefinically unsaturated monomer. The olefinically unsaturated monomer is herein defined as a polymerizable monomer comprising a carbon-carbon double bond. Suitable olefinically unsaturated monomers include, for example, alkenyl aromatic monomers, allylic monomers, acryloyl monomers, and the like, and mixtures thereof.

The alkenyl aromatic monomer may have the formula 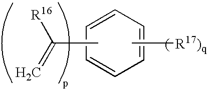
wherein each occurrence of R¹⁶ is independently hydrogen or C₁-C₁₈ hydrocarbyl; each occurrence of R¹⁷ is independently halogen, C₁-C₁₂ alkyl, C₁-C₁₂ alkoxyl, or C₆-C₁₈ aryl; p is 1 to 4; and q is 0 to 5. Unspecified positions on the aromatic ring are substituted with hydrogen atoms. Suitable alkenyl aromatic monomers include, for example, styrene, α-methylstyrene, 2-methylstyrene, 3-methylstyrene, 4-methylstyrene, 2-t-butylstyrene, 3-t-butylstyrene, 4-t-butylstyrene, 1,3-divinylbenzene, 1,4-divinylbenzene, 1,3-diisopropenylbenzene, 1,4-diisopropenylbenzene, styrenes having from 1 to 5 halogen substituents on the aromatic ring, and the like, and combinations thereof. Styrene is a particularly preferred alkenyl aromatic monomer.

The olefinically unsaturated monomer may be an allylic monomer. An allylic monomer is an organic compound comprising at least one, preferably at least two, more preferably at least three allyl (—CH₂—CH═CH₂) groups. Suitable allylic monomers include, for example, diallyl phthalate, diallyl isophthalate, triallyl mellitate, triallyl mesate, triallyl benzenes, triallyl cyanurate, triallyl isocyanurate, mixtures thereof, partial polymerization products prepared therefrom, and the like.

In a preferred embodiment, the olefinically unsaturated monomer may be an acryloyl monomer. An acryloyl monomer is a compound comprising at least one acryloyl moiety having the structure 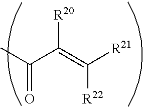
wherein R²⁰-R22 are each independently hydrogen, C₁-C₁₂ hydrocarbyl, C₂-C₁₈ hydrocarbyloxycarbonyl, nitrile, formyl, carboxylic acid, imidate, thiocarboxylic acid, or the like. In one embodiment, the acryloyl monomer comprises at least two acryloyl moieties. In another embodiment, the acryloyl monomer comprises at least three acryloyl moieties. Suitable acryloyl monomers include, for example, trimethylolpropane tri(meth)acrylate, 1,6-hexanediol di(meth)acrylate, neopentyl glycol di(meth)acrylate, ethylene glycol di(meth)acrylate, propylene glycol di(meth)acrylate, cyclohexanedimethanol di(meth)acrylate, butanediol di(meth)acrylate, diethylene glycol di(meth)acrylate, triethylene glycol di(meth)acrylate, isobornyl (meth)acrylate, methyl (meth)acrylate, methacryloxypropyl trimethoxysilane (also known as 3-(trimethoxysilyl)propyl methacrylate), ethoxylated (2) bisphenol A di(meth)acrylate (it will be understood that the number following the ethoxylated term refers to the average number of ethoxy groups in the ethoxylate chain attached to each oxygen of bisphenol A; where an acryloyl monomer is described as “ethoxylated” but no number is specified, any number of ethoxylate groups may be present), and the like, and mixtures comprising at least one of the foregoing acryloyl monomers.

The composition may generally comprise about 10 to about 30 parts by weight of the olefinically unsaturated monomer per 100 parts by weight total of the capped poly(arylene ether) and the olefinically unsaturated monomer. Within this range, it may be preferable to use an olefinically unsaturated monomer amount of at least about 20 parts by weight.

The composition optionally comprises about 0.2 to about 5 parts by weight of a curing initiator per 100 parts by weight total of the functionalized poly(arylene ether) and the olefinically unsaturated monomer. Within this range, the curing initiator amount is preferably at least about 0.5 parts by weight, more preferably at least about 1 part by weight, still more preferably at least about 1.5 parts by weight. Also within this range, the curing initiator amount is preferably up to about 4 parts by weight, more preferably up to about 3 parts by weight. In one embodiment, the curing initiator amount may be expressed in units of micromoles per gram of resin, where “resin” consists of the functionalized poly(arylene ether) and the olefinically unsaturated monomer. In this embodiment, the curing initiator amount is preferably at least about 100 micromoles per gram of resin.

Curing initiators, also referred to as curing catalysts, are well known in the art and may be used to initiate the polymerization, curing, or crosslinking of numerous thermoplastics and thermosets including unsaturated polyester, vinyl ester and allylic thermosets. Non-limiting examples of curing initiators include those described in U.S. Pat. Nos. 5,407,972 to Smith et al., and U.S. Pat. No. 5,218,030 to Katayose et al. The curing initiator may include any compound capable of producing free radicals at elevated temperatures. Such curing initiators may include both peroxy and non-peroxy based radical initiators. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, α,α′-bis(t-butylperoxy-m-isopropyl)benzene, 2,5-dimethyl-2,5-di(t-butylperoxy)hexane, di(t-butylperoxy) isophthalate, t-butylperoxy benzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and mixtures comprising at least one of the foregoing curing initiators. Suitable non-peroxy initiators include, for example, 2,3-dimethyl-2, 3-diphenylbutane, 2,3-trimethylsilyloxy-2,3-diphenylbutane, and the like, and mixtures comprising at least one of the foregoing curing initiators. The curing initiator for the unsaturated portion of the thermoset may further include any compound capable of initiating anionic polymerization of the unsaturated components. Such anionic polymerization initiators include, for example, alkali metal amides, such as sodium amide (NaNH₂) and lithium diethyl amide (LiN(C₂H₅)₂); alkali metal and ammonium salts of C₁-C₁₀ alkoxides; alkali metal and ammonium hydroxides; alkali metal cyanides; organometallic compounds such as the alkyl lithium compound n-butyl lithium; Grignard reagents such as phenyl magnesium bromide; and the like; and combinations comprising at least one of the foregoing anionic polymerization initiators. In a preferred embodiment, the curing initiator may comprise t-butylperoxy benzoate or dicumyl peroxide. The curing initiator may promote curing at a temperature in a range of about 0° C. to about 200° C.

The composition may also comprise about 0 to about 0.005 to about 1 part by weight of a curing inhibitor per 100 parts by weight total of the functionalized poly(arylene ether) and the olefinically unsaturated monomer. Within this range, the curing inhibitor amount may preferably be at least about 0.05 part by weight, more preferably at least about 0.1 part by weight. Also within this range, the curing inhibitor amount may preferably be up to about 0.5 part by weight, more preferably up to about 0.3 part by weight. In one embodiment, the curing inhibitor amount may be expressed in units of micromoles per gram of resin, where “resin” consists of the functionalized poly(arylene ether) and the olefinically unsaturated monomer. In this embodiment, the curing inhibitor amount is preferably at least about 50 micromoles per gram of resin.

Suitable curing inhibitors include, for example, diazoaminobenzene, phenylacetylene, sym-trinitrobenzene, p-benzoquinone, acetaldehyde, aniline condensates, N,N′-dibutyl-o-phenylenediamine, N-butyl-p-aminophenol, 2,4,6-triphenylphenoxyl, pyrogallol, catechol, hydroquinone, monoalkylhydroquinones, p-methoxyphenol, t-butylhydroquinone, C₁-C₆-alkyl-substituted catechols, dialkylhydroquinone, 2,4,6-dichloronitrophenol, halogen-ortho-nitrophenols, alkoxyhydroquinones, mono- and di- and polysulfides of phenols and catechols, thiols, oximes and hydrazones of quinone, phenothiazine, dialkylhydroxylamines, and the like, and combinations comprising at least one of the foregoing curing inhibitors. Suitable curing inhibitors further include uncapped poly(arylene ether)s (i.e., poly(arylene ether)s having free hydroxyl groups). With reference to the capped poly(arylene ether) structure Q(J-K)_{y}, above, the uncapped poly(arylene ether) may have the structure Q(J-H)_{y}, wherein each capping group K is replaced by a hydrogen atom, H. Preferred curing inhibitors include benzoquinone, hydroquinone, and 4-t-butylcatechol.

The weight ratio of the curing initiator to the curing inhibitor is about 1.2:1 to about 50:1. In some embodiments, the weight ratio is at least about 2:1 to about 20:1. In some other embodiments, the weight ratio is at least about 5:1 to about 12:1. The optimum weight ratio will depend on factors including the desired property balance, the identity of the curing initiator, the identity of the curing inhibitor, the type and amount of the functionalized poly(arylene ether), the type and amount of the olefinically unsaturated monomer, and the types and amounts of optional components. In one embodiment, the relative amounts of the curing initiator and the curing inhibitor may be specified as a molar ratio. In this embodiment, the molar ratio of the curing initiator to the curing inhibitor may be about 20:1 to about 1:1. Within this range, the molar ratio may preferably be at least about 2:1. Also within this range, the molar ratio may preferably be up to about 10:1, more preferably up to about 5:1.

The composition further comprises one or more fillers, including particulate fillers. A particulate filler is herein defined as a filler having an average aspect ratio less than about 5:1. Preferably, the filler includes at least two types of fillers having differing particle sizes. In one embodiment, the filler is preferably a finely divided mineral, which is substantially spherical and has a distributed particle size. In one embodiment, the finely divided mineral comprises silica, more specifically, at least 99 weight percent of silica (SiO₂). The silica is preferably selected from the group of fused silica, fumed silica, colloidal silica, and combinations thereof. In one embodiment, the silica is fused silica.

Preferred particulate fillers include fused silica having an average particle size of about 1 to about 50 micrometers. A particularly preferred particulate filler comprises a first fused silica having a median particle size of about 0.03 micrometer to less than 1 micrometer, and a second fused silica having a median particle size of at least 1 micrometer to about 30 micrometers. The preferred fused silica has essentially spherical particles, as may be achieved by re-melting. Within the size range specified above, the first fused silica may preferably have a median particle size of at least about 0.1 micrometer, preferably at least about 0.2 micrometer. Also within the size range above, the first fused silica may preferably have a median particle size of up to about 0.9 micrometer, more preferably up to about 0.8 micrometer. Within the size range specified above, the second fused silica may preferably have a median particle size of at least about 2 micrometers, preferably at least about 4 micrometers. Also within the size range above, the second fused silica may preferably have a median particle size of up to about 25 micrometers, more preferably up to about 20 micrometers. In one embodiment, the composition comprises the first fused silica and the second fused silica in a weight ratio in a range of about 70:30 to about 99:1, preferably in a range of about 80:20 to about 95:5.

The filler comprises a coating of adhesion promoters to improve adhesion. Adhesion promoters include silane coupling agents, or hydrolyzed polycondensed silane coupling agents. Silanes include molecules having the general structure (RO)₍₄₋ₙ₎SiYₙ wherein n=1-3, R is an alkyl or aryl group and Y is a reactive functional group which can enable formation of a bond with a polymer molecule. Particularly useful examples of coupling agents are those having the structure (RO)₃SiY. Typical examples include vinyl triethoxysilane, vinyl tris(2-methoxy)silane, phenyl trimethoxysilane, γ-methacryloxypropyltrimethoxy silane, γ-aminopropyltriethoxysilane, γ-glycidoxypropyltrimethoxysilane, γ-mercaptopropyltrimethoxysilane, and the like. The adhesion promoter may be coated onto any of the fillers described above to improve adhesion between the filler and the thermosetting resin. For example, such promoters may be used to coat a silicate fiber or filler to improve adhesion to the resin matrix. In one embodiment, the coating chemically reacts with the binder, thereby forming a chemical bond between the coating and the binder. The treatment of the fillers with adhesion promoter such as silane coupling agents may also enhance the mechanical properties of the curable compositions described herein.

The silane and filler are blended together prior to their blending with the resin of the present invention. The silane and filler are blended by any known methods, including blending in a Vee-blender equipped with a solids-liquids bar. The resulting coated filler is then cured. Curing is dependent on the coupling agent as would be known by one of skill in the art. Preferably, curing is at a temperature of about 60 to about 140° C. for about 1 to about 8 hours. More preferably, curing is at a temperature of about 80 to about 120° C., and even more preferably about 95° C. for about 4 hours.

Silane coupling agents of the types described above are readily hydrolyzed or partially hydrolyzed to the analogous silanols by contact with acidic alcoholic solutions of water. In the case of a blend of a silica filler and a hydrolyzed silane coupling agent, the silane coupling agent and the hydroxyl groups on the surface of the silica may give rise to a reaction whereby the silane coupling agent and the silica form a chemical bond. Reaction 1 illustrates the reaction between the hydrolyzed silane coupling agent (I) and silica (II) to form a coating of hydrolyzed condensed poly(silane) (III), wherein R₂₃ is an alkyl radical (R₂₃ should be replaced by H in the following equation (1)). In some embodiments R₂₃ is a methyl or an ethyl radical. Therefore the coating comprises a residual of coating comprises the residual of at least one organosilane selected from the group consisting of methoxy silane, dimethoxy silane, trimethoxy silane, ethoxy silane, diethoxy silane, triethoxy silane, and combinations thereof. In one embodiment, the coating comprises the residual of trimethoxy-y-methacyryloxypropyl silane.

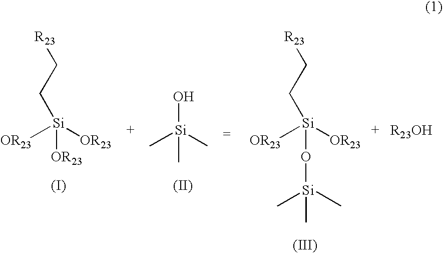

The filler may be used in an amount of about 5 to about 95 weight percent, based on the total weight of the composition. Within this range, it may be preferable to use a particulate filler amount of at least about 20 weight percent, more preferably at least about 40 weight percent, even more preferably at least about 70 weight percent, or any range therebetween. Also within this range, it may be preferable to use a particulate filler amount of up to about 93 weight percent, more preferably up to about 91 weight percent.

The curable composition may, optionally, further comprise one or more additives known in the art, such as, for example, dyes, pigments, colorants, antioxidants, heat stabilizers, light stabilizers, plasticizers, lubricants, flow modifiers, drip retardants, antiblocking agents, antistatic agents, flow-promoting agents, processing aids, substrate adhesion agents, mold release agents, toughening agents, low-profile additives, stress-relief additives, flame retardants, and the like, and combinations thereof. Those skilled in the art may select suitable additives and determine suitable amounts without undue experimentation.

There is no particular limitation on the method by which the composition is prepared, as long as it does not interfere with the ability of the cured composition to exhibit the desired property balance. The composition is preferably prepared by forming a resin or binder of the functionalized poly(arylene ether) and the olefinically unsaturated monomer. A curing initiator and/or curing inhibitor may also be added to the resin blend. The filler comprising a coating of hydrolyzed, condensed poly (silane) is prepared independnelty and cured as described herein. The binder and the filler are then mixed together to form a blend. The blend is cast to yield curable composition, which may be cured and used as an electronic material. The blend may then be molded by various applications known in the art. For example, the blend may be compression molded, transfer molded, liquid molded, injection molded, underfilled, syringe dispensed, spray coated, gravure coated, reverse-role coated, stencil printed, silk-screen printed, block printed, curtain coated, Meyer-rod coated, spray coated, or powder coated. A further embodiment of the present invention is a cured composition obtained by curing any of the above-described curable compositions. It will be understood that the term “curing” includes partially curing and fully curing. Because the components of the curable composition may react with each other during curing, the cured compositions may be described as comprising the reaction products of the curable composition components.

There is no particular limitation on the method by which the composition may be cured. The composition may, for example, be cured thermally or by using irradiation techniques, including radio frequency heating, UV irradiation and electron beam irradiation. For example, the composition may be cured by initiating chain-reaction curing with 10 seconds of radio frequency heating. When heat curing is used, the temperature selected may be in a range of about 800 to about 300° C. The heating period may be in a range of about 5 seconds to about 24 hours. In one embodiment, curing may be staged to produce a partially cured, hard plastic, which then is removed from the molding tool to an oven to be fully cured by heating for longer periods or at higher temperatures.

The composition described herein is useful as an electronic material composition in the assembly and/or sealing of electronic devices. An electronic device typically comprises a substrate-mounted device and an electronic material composition adjacent to the substrate and/or the device. The substrate-mounted device is in contact with the electronic material composition. The electronic device may be a semiconductor device, an integrated circuit, a photoelectronic device, a passivated electronic device such as a resistor, a capacitor or and inductor, or a circuit card comprising multiple active and/or passive electronic elements and the substrate of the electronic device may be selected from the group consisting of a metal, ceramic, polymer, composite, alloy, and combinations thereof, or any other substrates known in the art for electronic device construction. Accordingly, one embodiment of the invention is an electronic device comprising a substrate and an electronic material composition comprising a binder and filler. The binder is a blend of at least one functionalized poly(arylene ether) and at least one olefinically unsaturated monomer. The filler is comprises a hydrolyzed, condensed poly(silane) coating.

The substrate of the electronic device is typically a printed circuit board or a metallic lead frame. As is known in the art, the substrate may be provided as a carrier for a metallization pattern, which includes a die pad or a land grid array and a fan-out and/or redistribution pattern, on which an electronic component may be mounted, for instance, by an adhesive. Also, as is known in the art, the electronic component may be mounted by solder attach to the mounting area.

Representative electronic components, which may be encapsulated, are transistors, capacitors, relays, diodes, resistors, networks of resistors, integrated circuits, and the like. The electronic component typically is connected with wires or solder joints to the various pads. The wires are typically metal wires of gold or aluminum.

The electronic component and the wires, if present, are at least partially encapsulated with the electronic material composition in accordance with one embodiment of the present invention. The thickness of the composition generally ranges from about 0.1 to about 3.5 mm, more typically, about 0.5 to about 3.0 mm.

Sealing of the electronic device with the composition is typically achieved by transfer molding. The assembly of the substrate with the electronic component is placed in a transfer molding machine, which comprises a mold. The composition is optionally preheated and inserted into a hot transfer pot, and then forced from said pot into the hot mold cavity by means of provided runners and gates. The composition flows into the mold, at least partially encapsulating the electronic component and the associated bonding wires, and also the pads, the mounting areas, and the substrate. Upon solidification, the molded part-is ejected from the mold;

Techniques and equipment for performing transfer molding are well known to those skilled in the art, and transfer molding of the polymeric composition may be performed in accordance with the embodiment described above.

As is known in the art, the encapsulated device is optionally coated with a thin metal film, for example by vacuum deposition such as sputtering and/or evaporation, and them optionally coated with a thin protective coating, such as ENTEK® (sold by Enthone Inc.), SHERCOAT® (sold by Schering Company), or PROTECTO® (sold by Kester Solder Company). The optional coatings provide protection from electromagnetic interference, radio frequency interference, oxidation, and the like, as is known to those skilled in the art.

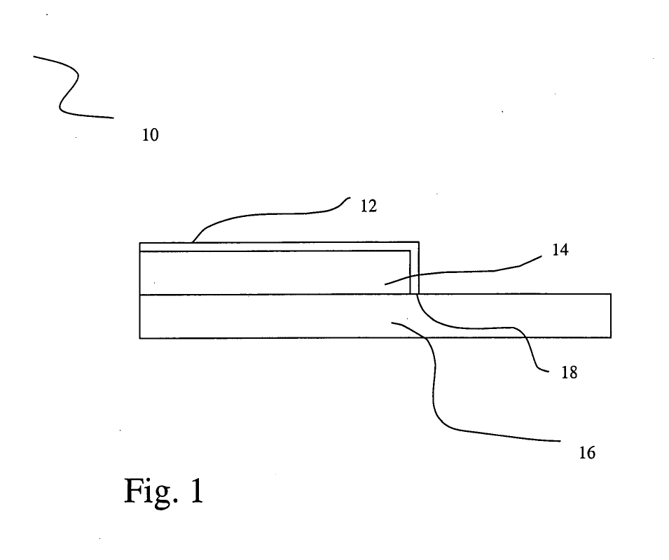

FIG. 1 illustrates a side view of an electronic device 10, wherein one substrate 16 is adjacent to an electronic component 14. The electronic component 14 is adjacent to an electronic packaging material 12, which electronic packaging material 12 is in contact with the substrate 16 along the surface 18. The electronic packaging material 12 comprises the electronic material compositions described herein.

The electronic material compositions as described in the preceding sections exhibits high flame retardancy as tested by UL 94 test. The electronic material compositions also exhibit excellent mechanical properties such as flexural strength, strain-to-break etc.

The invention is further illustrated by the following non-limiting examples.

### EXAMPLES

The filler was treated with the silane coupling agent using the method described in detail in the following examples. Generally, the silane coupling agent was dissolved in an alcohol/water solution buffer, which was adjusted to a pH of 5 140901-1 with acetic acid. The silica was tumbled in a Vee-blender (P-K Blend Master Lab Blender, 4 qt) at about 25 RPM. Two elliptical cavities were formed in the tumbling silica by the action of an intensifier bar that was rotated at about 3600 RPM. The silane solution was released into the blender as an aerosol from channels in the intensifier bar, and formed a coating on the silica on the perimeter of the ellipsoidal cavities. Due to the particular “V” shape of the tumble mixer shell, the silica moved vertically and horizontally, as the shell rotated, efficiently circulating the silica and promoting uniform coverage of the silane coupling agent. The uniformly coated silica was spread onto drying trays and processed at about 80° C. and 10-12 inches Hg vacuum for a period range from 5 minutes (Example 1) to 20 hrs (Example 3) in a vacuum oven adapted with a slow nitrogen purge inlet. It was found that important performance characteristics of the compositions of the invention were dependent on the length of this drying step. For convenience, this drying step is referred to as “post filler treatment heating”. The functionalized silica with a coating of hydrolyzed condensed poly (silane) was then used combined into a curable composition comprising a binder as described in the preceding sections.

### Example 1

Curable compositions were formulated as described herein. (a) A liquid acrylate monomer, ethoxylated (2) bisphenol A dimethacrylate (EBAM, Sartomer SR-348) and inhibitor 4-t-butyl catechol (It should be noted that methacrylate monomer SR-348 was supplied with a small amount (about 30 ppm) of inhibitor methyl hydroquinone.) along with (b) methacrylic acid anhydride-capped PPE, wherein the uncapped PPE demonstrates intrinsic viscosity of 0.30 cm³/g in 30° C. chloroform, sieved to pass 35 mesh, were mixed in a beaker at room temperature to form a resin slurry. The beaker containing the resin slurry was then immersed into an oil bath at a depth equal to the height of the slurry in the beaker. A variable speed mixer was inserted into the slurry to effect thorough mixing. The total time for immersion was 15 minutes ±15 seconds. The bath was maintained at 170 Deg C.±2 Deg C. and was sufficiently mechanically stirred so as to distribute the heat uniformly.

The beaker was removed from the oil bath and was stirred until the temperature decreased to 95 Deg C.±5 Deg C. Once the resin was cooled, pigment Keystone Green B, and flame retardant OP 930 (Clariant) were added. The initiator, dicumyl peroxide, was then added with continuous mixing for at least a minute. The resin mixture was then poured into sheets to cool to room temperature as quickly as possible.

The fillers were treated separately with a silane coupling agent as described herein. The silane coupling agent (Z-6030), ethanol and water were charged to a watertight container. Two drops of glacial acetic acid was added to the mixture. The container was sealed, and was sonicated at room temperature for 35 minutes. Appropriate amounts of silica (FB570 and SFP30M) were dispensed into a Vee-Blender in the proportion of 90% FB570 (larger particle size, Denka) and 10% SPF 30M (smaller particle size, Denka). The shell drive and the intensifier bar drive were started in that order. The silane solution was poured into the liquid feed tube and allowed to mix with the silica filler. The treated silica was dispensed in Pyrex trays and heated for 5 minutes at 80° C. in an oven under 10-15 inches Hg vacuum.

Once the resin mix and the treated silica were prepared, the two were mixed in a Brabender mixing bowl with a computer controlled roller blade mixer. Mixing was conducted for 5 minutes at 80° C. and a paddle speed of 60 rpm. Upon completion of the mixing cycle the compounded material was recovered from the bowl.

The amounts of each material added for each composition is listed in Table 1 together with the role and commercial source of each chemical and “post filler treatment heating” time.

TABLE 1

| | | | | Example 1 | Example 2 | Example 3 | Example 4 |
|---|---|---|---|---|---|---|---|
| | | | Commercial | Weight | Weight | Weight | Weight |
| | Component | | source | (grams) | (grams) | (grams) | (grams) |
| Filler | FB570 | Filler | Denka | 398.10 | 398.10 | 398.10 | 398.10 |
| | SFP30M | Filler | Denka | 44.20 | 44.20 | 44.20 | 44.20 |
| | Z6030 | silane | Aldrich | 3.93 | 3.93 | 3.93 | 0.00 |
| | | coupling | | | | | |
| | | agent (3- | | | | | |
| | | (trimethoxysilyl) | | | | | |
| | | propyl | | | | | |
| | | methacrylate | | | | | |
| | Filler Total | | | 446.23 | 446.23 | 446.23 | 442.30 |
| | weight | | | | | | |
| | Filler percent of | | | 85.00 | 85.00 | 85.00 | ˜85 |
| | total | | | | | | |
| | Post filler | | | 5 min. | 2 hr | 20 hr | none |
| | treatment | | | | | | |
| | heating time | | | | | | |
| | methacrylic | | General | 15.75 | 15.75 | 15.75 | 15.75 |
| | acid anhydride- | | Electric Co. | | | | |
| | capped PPE | | | | | | |
| | Ethoxylated (2) | | Sartomer | 52.76 | 52.76 | 52.76 | 52.76 |
| | Bisphenol A | | | | | | |
| | Dimethacrylate | | | | | | |
| | (EBAM, SR - | | | | | | |
| | 348) | | | | | | |
| | Keystone Green B | Pigment | Keystone | 0.24 | 0.24 | 0.24 | 0.24 |
| | 4-t-butyl | Inhibitor | Avocado | 0.16 | 0.16 | 0.16 | 0.16 |
| | catechol | | | | | | |
| | OP 930 | Flame | Clariant | 7.88 | 7.88 | 7.88 | 7.88 |
| | | Retardant | | | | | |
| | Dicumyl | Initiator | Aldrich | 1.97 | 1.97 | 1.97 | 1.97 |
| | peroxide | | | | | | |
| | Resin total | | | 78.75 | 78.75 | 78.75 | 78.75 |
| | weight | | | | | | |
| | Resin percent of | | | 15.00 | 15.00 | 15.00 | ˜15 |
| | total | | | | | | |

### Examples 2-4

The compositions of Examples 2-3 were prepared using a procedure essentially identical to that used in Example 1 with the exception of the post filler treatment heating time employed. Compositional data and post filler treatment heating time employed for Examples 2-3 are given in Table 1. The composition of Example 4 was prepared via a procedure similar to the procedure of Example 1 with the exception that the silica fillers employed were not subjected to treatment with the silane coupling agent.

The curable compositions of Examples 1-4 were processed to make molded test specimens as follows. Approximately 50 grams of each curable composition was compression molded (at 1000 psi pressure and 150° C. mold temperature) into a 10 cm diameter×3.2 mm disk. The disk was cut into individual test specimens, which were approximately 12.7 mm wide. Specimens were made from each of the curable compositions of Examples 1-4. The molded test specimens were then cured by heating at 175±10° C. for 2 hours ±10 minutes, and subjected to the UL 94 flammability test and moisture sensitivity testing.

Four test specimens prepared from each of the molded disks prepared from the compositions of Examples 1-4 were subjected to a flammability test in accordance with test standard UL94 Test for Flammability & Plastic Materials for Parts In Devices & Appliances (ISBN 0-7629-0082-2, Jul. 10, 1998). Cumulative burn time data were gathered for each composition. In a cumulative burn test, a V-0 rating is indicative of the lowest level of flammability, as is known in the art. Of the compositions of Examples 1-3, only the composition of Example 3 met the V-0 standard. Because compositions 1-3 were identical in every respect save the post filler treatment heating time, it is clear that insufficient post filler treatment heating time accounts for poorer performance in the UL94 flammability test. Comparison of the result in the UL94 test for the composition of Example 3 with that of Example 4 demonstrates that treatment of the silica fillers with a silane coupling agent produces compositions which may have a higher degree of flammability than compositions prepared with untreated silica fillers if the post filler treatment heating time is insufficiently long. While this may appear to be a deficiency of compositions comprising silane treated silica fillers, this deficiency is offset by other advantages,which are made apparent in Examples 5 and 6 below.

### Examples 5 and 6

The compositions of Examples 5 and 6 were prepared analogously to the procedure given for Example 1. In Example 5, the silica filler was treated with a silane coupling agent. In Example 6, the silica filler was not treated with a silane coupling agent. In each of Examples 5 and 6 curable compositions were prepared in a Brabender mixing bowl as in Example 1. After a portion (approximately ⅓) of the dry components such as silica and OP 1311 were added into the bowl, the resin portion was added. The remaining dry components were then added and mixed for a total compounding time of 5 minutes. The amounts of each material added for each composition are listed in Table 2 together with the role and commercial source of each chemical.

The compositions prepared in Examples 5 and 6 were tested in flexure per ASTM D790-03 for mechanical properties including flexural strength and strain-to-break. The compositions were molded into Izod specimens on a Fujiwa press using a 35-gram charge, with a 2-minute molding cycle at 150° C. The plunger pressure was kept at 1000 psi. Molded Izod bars were cured at 175 ° C. for 2 hours prior to testing.

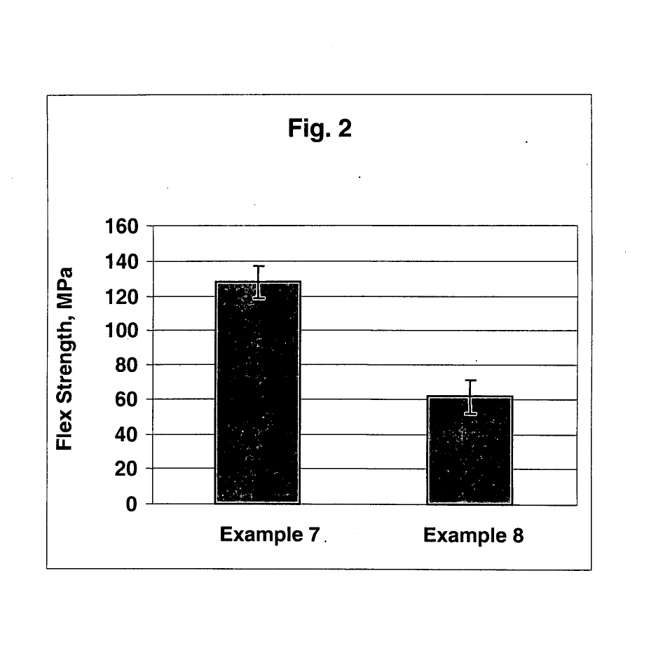

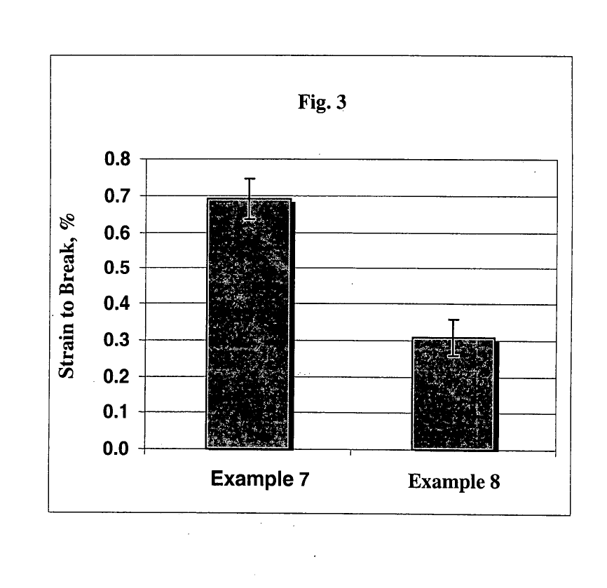

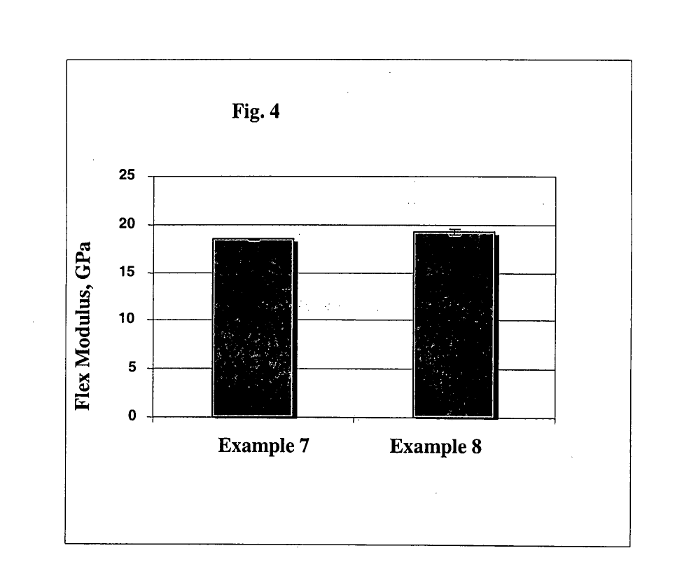

The results of the mechanical tests performed on the samples prepared from compositions of examples 5 and 6 are illustrated in FIGS. 2-4. FIG. 2 illustrates flexural strength for the compositions of examples 5 and 6. As shown in FIG. 2, flexural strength was enhanced when the composition (example 5) comprises silica treated with the appropriate silane coupling agent according to the method of the present invention. In example 6, the silica was used without the silane treatment. Similarly in FIG. 3, the strain-to-break observed for samples prepared from the composition of Example 5 was higher compared to the sample prepared from the composition of Example 6. Both the flexural strength data and the strain to break data show that when the silica used in the curable compositions was treated with the appropriate silane coupling agent following the method of the present invention, the mechanical properties exhibited by the compositions were superior compared to compositions wherein the silica was not treated with silane coupling agents. FIG. 3 shows the flexural modulus measured for the compositions of examples 5 and 6. No significant differences were observed.

TABLE 2

| | | | | Example 5 | Example 5 | Example 6 | Example 6 |
|---|---|---|---|---|---|---|---|
| | | | Commercial | (weight | Weight | (weight | Weight |
| | Component | | source | percent) | (grams) | percent) | (grams) |
| Filler | FB570 | Filler | Denka | 76.5 | | 76.5 | |
| | SFP30M | Filler | Denka | 8.5 | | 8.5 | |
| | Z6030 | silane | Aldrich | 0.57 | | | |
| | | coupling | | | | | |
| | | agent (3- | | | | | |
| | | (trimethoxysilyl) | | | | | |
| | | propyl | | | | | |
| | | methacrylate | | | | | |
| | Filler Total | | | | 462.08 | | 459.0 |
| | weight | | | | | | |
| | Filler percent of | | | 85.00 | | 85.00 | |
| | total | | | | | | |
| | methacrylic | | General | 1.71 | 11.51 | 1.78 | 11.51 |
| | acid | | Electric Co. | | | | |
| | anhydride- | | | | | | |
| | capped PPE | | | | | | |
| | Ethoxylated (2) | | Sartomer | 9.67 | 65.22 | 10.07 | 65.22 |
| | Bisphenol A | | | | | | |
| | Dimethacrylate | | | | | | |
| | (EBAM, SR - | | | | | | |
| | 348) | | | | | | |
| | Keystone Green B | Pigment | Keystone | 0.1 | 0.648 | 0.1 | 0.648 |
| | 4-t-butyl | Inhibitor | Avocado | 0.063 | 0.43 | 0.066 | 0.43 |
| | catechol | | | | | | |
| | OP 1311 | Flame | Clariant | 1.25 | 6.77 | 1.31 | 7.05 |
| | | Retardant | | | | | |
| | Dicumyl | Initiator | Aldrich | 0.380 | 2.05 | 0.396 | 2.14 |
| | peroxide | | | | | | |
| | SMA | Adhesion | | 0.86 | 5.78 | 0.89 | 5.78 |
| | | Promoter | | | | | |
| | Resin percent | | | 15.00 | | ˜15.00 | |
| | of total | | | | | | |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A composition comprising:
(a) a curable binder, said binder comprising at least one functionalized poly(arylene ether) and at least one olefinically unsaturated monomer; and
(b) a filler, said filler comprising a coating of hydrolyzed, condensed poly (silane).

2. The composition according claim 1, wherein said functionalized poly(arylene ether) resin comprises a capped poly(arylene ether) resin having the formula
Q(J-K)_{y}
wherein Q is the residuum of a monohydric, dihydric, or polyhydric phenol; y is 1 to 100; J comprises repeating structural units having the formula 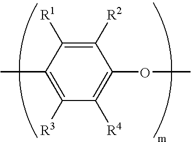
wherein R¹ and R³ are each independently selected from the group consisting of hydrogen, halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; R² and R⁴ are each independently selected from the group consisting of halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; m is 1 to about 200; and K is a capping group selected from the group consisting of 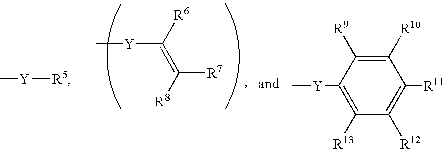
wherein R⁵ is C₁-C₁₂ hydrocarbyl optionally substituted with one or two carboxylic acid groups, R⁶-R⁸ are each independently hydrogen, C₁-C₁₈ hydrocarbyl optionally substituted with one or two carboxylic acid groups, C₂-C₁₈ hydrocarbyloxycarbonyl, nitrile, formyl, carboxylic acid, imidate, and thiocarboxylic acid; R⁹-R¹³ are each independently selected from the group consisting of hydrogen, halogen, C₁-C₁₂ alkyl, hydroxy, carboxylic acid, and amino; and wherein Y is a divalent group selected from the group consisting of 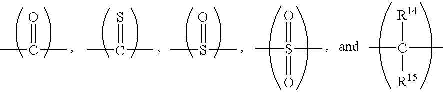
wherein R¹⁴ and R¹⁵ are each independently selected from the group consisting of hydrogen and C₁-C₁₂ alkyl.

3. The composition according claim 1, wherein said functionalized poly(arylene ether) comprises a capped poly(arylene ether) comprising at least one capping group having the structure 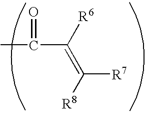
wherein each occurrence of R⁶-R⁸ is independently hydrogen, C₁-C₁₈ hydrocarbyl optionally substituted with one or two carboxylic acid groups, C₂-C₁₂ hydrocarbyloxycarbonyl, nitrile, formyl, carboxylic acid, imidate, and thiocarboxylic acid.

4. The composition according claim 1, wherein said poly(arylene) ether comprises poly(2,6-dimethyl-1,4-phenylene ether.

5. The composition according claim 1, wherein said functionalized poly(arylene ether) has a number average molecular weight of about 1,000 to about 20,000 atomic mass units.

6. The composition according claim 1, wherein said olefinically unsaturated monomer comprises at least one selected from the group consisting of an alkenyl aromatic monomer, an allylic monomer, an acryloyl monomer, and mixtures thereof.

7. The composition according claim 1, wherein said olefinically unsaturated monomer comprises an alkenyl aromatic monomer having the formula 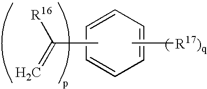
wherein each occurrence of R¹⁶ is independently hydrogen or C₁-C₁₈ hydrocarbyl; each occurrence of R¹⁷ is independently halogen, C₁-C₁₂ alkyl, C₁-C₁₂ alkoxyl, or C₆-C₁₈aryl; p is 1 to 4; and q is 0 to 5.

8. The composition according claim 1, wherein said olefinically unsaturated monomer comprises an allylic monomer selected from the group consisting of diallyl phthalate, diallyl isophthalate, triallyl mellitate, triallyl mesate, triallyl benzenes, triallyl cyanurate, triallyl isocyanurate, combinations and mixtures thereof, and partial polymerization products prepared therefrom, an alkenyl aromatic monomer selected from the group consisting of styrene, α-methylstyrene, 2-methylstyrene, 3-methylstyrene, 4-methylstyrene, 2-t-butylstyrene, 3-t-butylstyrene, 4-t-butylstyrene, 1,3-divinylbenzene, 1,4-divinylbenzene, 1,3-diisopropenylbenzene, 1,4-diisopropenylbenzene, styrenes having from 1 to 5 halogen substituents on the aromatic ring, and combinations and mixtures thereof.

9. The composition according claim 1, wherein the olefinically unsaturated monomer comprises styrene.

10. The composition according claim 1, wherein said olefinically unsaturated monomer comprises an acryloyl monomer comprising at least one acryloyl moiety having the structure 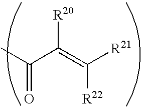
wherein R²⁰-R²² are each independently selected from hydrogen, C₁-C₁₂ hydrocarbyl, C₂-C₁₈ hydrocarbyloxycarbonyl, nitrile, formyl, carboxylic acid, imidate, and thiocarboxylic acid.

11. The composition according claim 1, wherein the olefinically unsaturated monomer comprises an acryloyl monomer comprising at least two acryloyl moieties.

12. The curable composition according claim 1, wherein said olefinically unsaturated monomer comprises an acryloyl monomer selected from the group consisting of trimethylolpropane tri(meth)acrylate, 1,6-hexanediol di(meth)acrylate, neopentyl glycol di(meth)acrylate, ethylene glycol di(meth)acrylate, propylene glycol di(meth)acrylate, cyclohexanedimethanol di(meth)acrylate, butanediol di(meth)acrylate, diethylene glycol di(meth)acrylate, triethylene glycol di(meth)acrylate, isobornyl(meth)acrylate, methyl(meth)acrylate, methacryloxypropyl trimethoxysilane, ethoxylated (2) bisphenol A di(meth)acrylate, and combinations and mixtures thereof.

13. The composition according to claim 1, comprising about 10 to about 30 parts by weight of the olefinically unsaturated monomer per 100 parts by weight total of said functionalized poly(arylene ether) and said olefinically unsaturated monomer.

14. The composition according to claim 1, wherein said filler further comprises a substantially finely divided mineral.

15. The composition according to claim 14, wherein said finely divided mineral is substantially spherical and has a substantially distributed particle size.

16. The composition according to claim 14, wherein the particle size of said filler ranges from about 0.02 to about 100 microns.

17. The composition according to claim 14, wherein said finely divided mineral comprises silica.

18. The composition according to claim 17, wherein said silica is selected from the group consisting of fused silica, fumed silica, colloidal silica, and combinations thereof.

19. The composition of claim 18 wherein said silica is fused silica.

20. The composition according to claim 1, wherein said coating comprises the residual of at least one organosilane selected from the group consisting of methoxy silane, dimethoxy silane, trimethoxy silane, ethoxy silane, diethoxy silane, triethoxy silane, and combinations thereof.

21. The composition according to claim 1, wherein said coating comprises the residual of trimethoxy-γ-methacyryloxypropyl silane.

22. An electronic device comprising:
(a) a substrate; and
(b) an electronic material composition adjacent to said substrate, said electronic material composition comprising a curable binder, said binder comprising at least one functionalized poly(arylene ether) and at least one olefinically unsaturated monomer, and a filler wherein the filler comprises a coating of hydrolyzed, condensed poly (silane).

23. The device according to claim 21, wherein said substrate is selected from the group consisting of a metal, a ceramic, a polymer, a composite, an alloy, and combinations thereof.

24. The device according to claim 21, wherein said poly(arylene ether) is a methacrylate-capped poly(arylene ether).

25. The device according to claim 21, wherein said poly(arylene ether) comprises polyphenylene oxide.

26. The device according to claim 21, wherein said filler further comprises a substantially finely divided mineral.

27. The device according to claim 25, wherein said filler is a finely divided mineral that is substantially spherical and has a substantially distributed particle size.

28. The device according to claim 26, wherein said finely divided mineral comprises at least 99 weight percent of silica and wherein said silica comprises at least one selected from the group consisting of fused silica, fumed silica, colloidal silica, and combinations thereof.

29. The device according to claim 21, wherein said coating comprises the residual of at least one selected from the group consisting of methoxy silane, dimethoxy silane, trimethoxy silane, ethoxy silane, diethoxy silane, triethoxy silane, and combinations thereof.

30. A method of making an electronic material composition, said method comprising:
(a) providing a curable binder, said binder comprising at least one functionalized poly(arylene ether) and at least one olefinically unsaturated monomer;
(b) providing a filler comprising a coating of hydrolyzed, condensed poly (silane); and
(c) mixing said binder and filler to form a blend.

31. The method according to claim 29 comprising the additional step of curing the binder and filler blend prior to the step of casting the blend.

32. The method according to claim 29, wherein said polyarylene ether is polyphenylene oxide.

33. The method according to claim 29, wherein said filler further comprises a substantially finely divided mineral.

34. The method according to claim 32, wherein said finely divided mineral is substantially spherical and has a substantially distributed particle size.

35. The composition according to claim 32, wherein said finely divided mineral comprises silica.

36. The method according to claim 34, wherein said silica is selected from the group consisting of fused silica, fumed silica, colloidal silica, and combinations thereof.

37. The method according to claim 32, wherein said coating comprises the residual of an organosilane selected from the group consisting of methoxy silane, dimethoxy silane, trimethoxy silane, ethoxy silane, diethoxy silane, triethoxy silane, and combinations thereof.
